(19) United States
(12) Patent Application Publication
(10) Pub. No.: US 2024/0345874 A1
(43) Pub. Date: Oct. 17, 2024

(54) COMPUTING NATIVE NETWORK AND RELATED DEVICES

(71) Applicant: ASIAINFO TECHNOLOGIES (CHINA), INC., BEIJING (CN)

(72) Inventors: Ye OUYANG, BEIJING (CN); Leiming MA, BEIJING (CN); Peng LV, BEIJING (CN); Zhigang WANG, BEIJING (CN); Jie SUN, BEIJING (CN)

(73) Assignee: ASIAINFO TECHNOLOGIES (CHINA), INC., BEIJING (CN)

(21) Appl. No.: 18/210,450

(22) Filed: Jun. 15, 2023

(30) Foreign Application Priority Data
Apr. 14, 2023 (CN) 202310397947.X

(51) Int. Cl. G06F 9/48

(52) U.S. Cl. CPC G06F 9/4881

(57) ABSTRACT

A computing provider side device and a computing scheduling management side device in a wireless communication system are proposed. The computing scheduling management side device can collect computing related information about shareable computing from the computing provider side, and information about an application on a computing consumer side that needs to utilize the computing, and perform computing scheduling for the application based on the information. The computing provider side device can determine and provide its shareable computing for being scheduled for the applications on the provider side, and such shareable computing also can be released so as to be reused by the computing provider side device.

### CROSS-REFERENCE OF RELATED APPLICATIONS

The present application claims the benefit of priority to CN application Ser. No. 202310397947.X filed on Apr. 14, 2023, which is incorporated by reference herein in its entity.

### FIELD OF THE INVENTION

The present disclosure relates to a wireless network, and more particularly, to the computing resource scheduling in a wireless network.

### BACKGROUND

With the development of 5G technology, the functions of base stations are becoming more and more comprehensive, and more and more tasks can be undertaken. However, due to the tidal phenomenon in the 5G wireless network, the network load is not always balanced from time to time, which will lead to a waste of computing resources of a base station when the load is low.

Unless otherwise stated, it should not be assumed that any of the methods described in this section become prior art only because they are included in this section. Similarly, unless otherwise stated, the problems recognized about one or more methods should not be assumed to be recognized in any prior art on the basis of this section.

### DISCLOSURE OF THE INVENTION

The present disclosure proposes a mechanism for optimizing computing scheduling of Network Elements in a wireless network, and this disclosure aims to make one Network element handle both network service and computing service at the same time without adding separate computing cards.

An aspect of the present disclosure relates to a device on a computing scheduling management side in a wireless communication system, comprising a processing circuit configured to: collect computing related information, wherein the computing includes shareable computing that can be provided by a computing provider side: collect information about an application on a computing consumer side that needs to utilize the computing, and perform computing scheduling for the application based on the computing related information and the information about the application, wherein the information about the application includes application attribute information, and the computing scheduling for the application includes corresponding computing scheduling for the application based on the application attribute.

Another aspect of the present disclosure relates to a device on a computing provider side in a wireless communication system, comprising a processing circuit configured to: collect computing related information, wherein the computing includes shareable computing that can be provided by the computing provider side, provide the computing related information to a device on a computing scheduling management side, and receive information about computing scheduling from the device on the computing scheduling management side, so that an application on a computing consumer side indicated in the information about computing scheduling can be executed by utilizing the computing.

Another aspect of the present disclosure relates to a method for a computing scheduling management side in a wireless communication system, which comprises: collecting computing related information, wherein the computing includes shareable computing that can be provided by a computing provider side: collecting information about an application on a computing consumer side that needs to utilize the computing, and performing computing scheduling for the application based on the computing related information and the information about the application, wherein the information about the application includes application attribute information, and the computing scheduling for the application includes corresponding computing scheduling for the application based on the application attribute.

Another aspect of the present disclosure relates to a method for a computing provider side in a wireless communication system, which comprises: collecting computing related information, wherein the computing includes shareable computing that can be provided by the computing provider side, providing the computing related information to a device on a computing scheduling management side, and receiving information about computing scheduling from the device on the computing scheduling management side, so that an application on a computing consumer side indicated in the information about computing scheduling can be executed by utilizing the computing.

Yet another aspect of the present disclosure relates to a non-transitory computer-readable storage medium storing executable instructions thereon, which, when executed by a processor, cause the processor to implement the methods as described herein.

Yet another aspect of the present disclosure relates to a device that comprises a processor and a storage device having stored executable instructions thereon, which, when executed by the processor, cause the processor to implement the methods as described herein.

Yet another aspect of the present disclosure relates to a computer program product comprising executable instructions which, when executed by the processor, cause the processor to implement the method as described herein.

Yet another aspect of the present disclosure relates to a computer program comprising instructions and/or codes which, when executed by the processor, cause the processor to implement the methods as described herein.

This section is intended to provide a brief overview of some concepts which will be further described in the following detailed description. This section is not intended to identify key features or basic features of subject matters to be protected, nor limit the scopes of the subject matters to be protected. Other aspects and advantages of the present disclosure will become apparent from the following detailed description of embodiments and figures.

### DESCRIPTION OF THE DRAWINGS

Hereinafter, the above and other objects and advantages of the present disclosure will be further described in combination with specific embodiments with reference to the accompanying drawings. In the drawings, the same or like technical features or components will be denoted by the same or like reference numerals.

FIG. 1 schematically illustrates a conceptual diagram of computing scheduling for a wireless network according to an embodiment of the present disclosure.

FIG. 2 schematically illustrates an exemplary architecture diagram of computing scheduling according to an embodiment of the present disclosure.

FIG. 3 illustrates a conceptual signaling diagram of temporary computing resource scheduling according to an embodiment of the present disclosure.

FIG. 4 illustrates an exemplary implementation of computing scheduling according to an embodiment of the present disclosure.

FIG. 5A illustrates a block diagram of a device on the computing scheduling management side according to an embodiment of the present disclosure, and FIG. 5B illustrates a flowchart of a method for the computing scheduling management side according to an embodiment of the present disclosure.

FIG. 6 illustrates an exemplary procedure of computing decision for computing distribution according to an embodiment of the present disclosure.

FIG. 7A illustrates a flow chart of establishing a computing native service according to an embodiment of the present disclosure, and FIG. 7B illustrates a flow chart of revoking a computing native service according to an embodiment of the present disclosure.

FIGS. 8A and 8B illustrate schematic diagrams of application migration according to an embodiment of the present disclosure.

FIG. 9A illustrates a schematic diagram of application migration according to a first embodiment of the present disclosure.

FIG. 9B illustrates a schematic diagram of application migration according to a second embodiment of the present disclosure.

FIG. 10 illustrates an exemplary implementation of a MEC according to an embodiment of the present disclosure.

FIG. 11A illustrates an exemplary block diagram of a device on the computing provider side according to an embodiment of the present disclosure, and FIG. 11B illustrates an exemplary flowchart of a method for the computing provider side according to an embodiment of the present disclosure.

FIG. 12 illustrates an exemplary implementation of a BBU according to an embodiment of the present disclosure.

FIG. 13 illustrates an overview of a computer system in which a method according to an embodiment of the present disclosure can be implemented.

Embodiments of this disclosure may be susceptible to various modifications and alternative forms, and the embodiments of the present disclosure are shown by way of example in the drawings and are described in detail herein. It should be understood that the drawings and detailed description thereof are not intended to limit the embodiments to the particular forms disclosed, on the contrary, the intention is to cover all modifications, equivalents, and alternatives falling within the spirit and scope of the claims.

### DETAILED DESCRIPTION OF PREFERRED EMBODIMENTS

Hereinafter, exemplary embodiments of the present disclosure will be described with reference to the accompanying drawings. For the sake of clarity and conciseness, not all features of the embodiments are described in the description. However, it should be understood that many implementation-specific settings must be made during the implementation of the embodiments in order to achieve specific goals of developers, for example, to meet those constraints related to equipment and business, and these constraints may vary with different implementations. In addition, it should be understood that although the development work may be very complicated and time-consuming, it is only a routine task for those skilled in the art who benefit from this disclosure.

Here, it should also be noted that in order to avoid obscuring the present disclosure by unnecessary details, only processing steps and/or equipment structures closely related to the schemes at least according to the present disclosure are shown in the drawings, while other details not closely related to the present disclosure are omitted. It should be noted that similar reference numerals and letters indicate similar items in the drawings, and therefore, once an item is defined in one drawing, there is no need to discuss it for subsequent drawings.

In this disclosure, the terms “first”, “second” and the like are only used to distinguish elements or steps, and are not intended to indicate time sequence, preference or importance.

With booming development of 5G network and of new businesses (such as industrial manufacturing, cloud games, etc.), the trend of demanding integration of wireless network and edge computing has become more and more obvious, such as the design of MEC (Multi-access Edge Computing) integrated machine in 5G private network. As specified by the European Telecommunications Standardization Association (ETSI), MEC can refer to a system that provides IT business environment and cloud computing capacity in an access network containing one or more access technologies, at the network edge close to users, so that computing resources can sink from the base station center or cloud center to the network edge devices (such as mobile radio base stations, home routing, etc.) close to users, thus contributing to the realization of large-scale real-time calculation. On the other hand, with the development of network Artificial Intelligence (AI), it is also a kind of research direction to use the computing of network elements to complete AI calculation.

At present, a method of utilizing computing by a single base station for self-network performance optimization has been proposed, in which the wireless network coverage ability of the single base station can be adjusted by allowing the implementation of AI algorithm by itself. It is also proposed that a base station cooperates with neighboring base stations through the network AI to realize the load balance of wireless communication data.

The above scheme essentially belongs to a category of network AI scheme. However, the current network AI scheme is mainly oriented to network optimization, and the computing of a single base station hardware fails to concurrently support multiple categories of services, such as network service and computing service. Moreover, in the existing schemes, in order to support computing businesses, it is necessary to increase additional investment to purchase additional computing servers or computing boards, which will increase the overhead. Furthermore, it is impossible to optimize usage of computing resources of base stations. Moreover, in the current scheme, it is also impossible to realize the ability of lossless application service migration based on application service awareness.

In addition, the current optimization scheme for integrated network elements mainly involves the deployment of integrated machines themselves. However, the current integrated device is limited by its internal components, which are usually large in size, high in power consumption, high in cost and poor in performance, particularly, it can only achieve a fixed computing configuration rigidly based on the existing or set situation, without considering dynamic scheduling and distribution of computing, which makes the energy efficiency of each component in the integrated device poor. Especially, in the current integrated network optimization, the optimization or improvement of simultaneous support for multiple services, such as network services and computing services, is not considered, the optimal utilization and scheduling of distributed BBU computing resources in the wireless network cannot be realized. Furthermore, in the current integrated network optimization the ability of lossless migration of application services based on application service awareness cannot be realized.

In view of this, the present disclosure provides an improved mechanism for scheduling computing resources in a wireless network. In particular, computing resources can refer to data processing capacities that can support applications or business requirements, such as processing capacities of various processors, processing hardwares, etc. (e.g., CPU, GPU, etc.), and can also be referred to as “computing” in the following. Of course, computing resources can also correspond to various processors, processing hardwares, etc., which provide processing capacities, and will not be described in detail here.

On one hand, the present disclosure proposes a computing native network, which can be established based on existing devices in a wireless network without additionally increasing computing sources, and in particular, can realize dynamic distribution of computing by utilizing the native computing of each device in the wireless network. The native computing here can include the computing provided by the devices in the wireless network themselves, including the computing that are sharable besides that available for the basic services. That is, the computing of the existing service devices in the wireless network is multiplexed, thus effectively improving utilization efficiency of the computing.

In particular, the scheme of the present disclosure determines the computing that the wireless network can provide, and dynamically allocates the computing that the wireless network can provide based on the application requirement of the system, so that the wireless network can provide computing to support applications/services while providing network services.

Furthermore, in addition to the computing provided by the wireless network, the computing native network of the present disclosure can also cover or incorporate other appropriate computing resources, such as cloud computing, so that dynamic distribution and release of more abundant computing can be utilized and implemented.

On the other hand, additionally, according to the embodiment of the present disclosure, the scheme of the present disclosure also proposes to properly classify or partition applications and/or computing of the system, and to optimize the scheduling of computing based on the characteristics and/or requirements of the applications, so that the network service can be guaranteed without damage, and the lossless migration of the application service can be guaranteed, during the scheduling of computings.

The scheme of the present disclosure can be implemented in various ways. In particular, the scheme of the present disclosure preferably constructs and utilizes various appropriate computing networks, and can implement optimal scheduling of computings in the computing networks for applications. The computing network can contain various types of computing, and each device or node included in the computing network that can provide the computing can be referred to as a computing node, so that application services can be distributed among computing nodes in the computing network. In some embodiments, the computing network includes a computing native network, in which computing nodes can correspond to various appropriate types of base stations or related servers that can provide computing, so that the base stations can provide network services and application services concurrently, thus enabling concurrent support for multiple services, such as network services and computing services. In other embodiments, additionally or alternatively, the computing network may also include any other appropriate computing/computing nodes, such as cloud computing resources/computing nodes, which may be combined with the computing native network, so as to realize a computing network with more comprehensive computing.

In some embodiments, the scheme of the present disclosure can optimize the existing system architecture. As an example, the scheme of the present disclosure can be based on a 5G SA system architecture of 3GPP standard, and can be implemented by adding functions to 5G BBU (Building Base band Unit) and edge MEC platform. 5G BBU is a kind of distributed base station architecture widely used in the network, which can provide 3GPP standardized network business services, such as user network access, data transmission and so on. Through the scheme of the present disclosure, the BBU native computing can be provided, and network services and computing services can be supported, without needing to add computing boards or computing services additionally.

It should be pointed out that the scheme of the present disclosure can belong to an improved edge computing scheme. Edge computing is a kind of computing mode in which services and computing resources are placed in network edge devices close to terminal users. In particular, edge computing can realize the integration between users' local computing and cloud computing, by optimally deploying normal operations in cloud computing to devices at the network edge close to users or data sources, such as mobile cellular network communication base stations, home routers, any other appropriate devices for configuring the computing and storage resources, etc., it can meet key requirements of industry digitalization in terms of quick connection, real-time services, data optimization, application intelligence, security and privacy protection, etc.

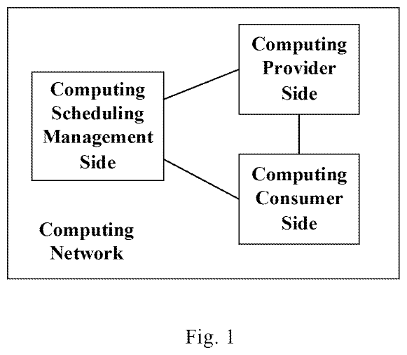

Exemplary implementations of embodiments of the present disclosure will be described in detail below, especially with reference to wireless networks, especially computing native networks. In the context of the present disclosure, as an implementation, a computing native network may include a computing scheduling/management side, a computing provider side, and a computing consumer side, as shown in FIG. 1. Among them, the computing scheduling management side can manage shareable computings provided by the computing provider side and/or perform scheduling in accordance with the requirements of the computing consumer side.

The computing scheduling management side can collect information about computing of each computing node in the computing native network and information about an application that needs computings to operate, and then schedule the computing according to availability of the computing and requirement of the application, including computing distribution, adjustment and release. A computing node can correspond to a node that provides computing, especially a device that can provide shareable computing, such as a device on the computing provider side. In particular, as an example, the computing scheduling management side may include at least one of the computing scheduling side and the computing management side. The computing management side may be involved in accepting and managing the computing or computing nodes provided by the computing provider side, for example, accepting them into the computing native network to manage, and the computing scheduling side may be involved in scheduling the computing nodes according to the application requirements, especially allocating the computing for the application requirements. In some embodiments, the computing scheduling management side device may be referred to as a computing scheduling manager, which may include a computing scheduler and/or a computing manager, which may be implemented separately or integrated together. The computing scheduling manager may include, but not limited to, at least one of a network controller, an edge computing controller, and the like. Applications here can be called edge applications, which can include all kinds of applications that need to use the computing to perform operations or provide services.

The computing provider side can provide various appropriate types of computing, which can also be called edge computing, which can include at least one of network native computing, cloud computing, and so on. The computing provider side may include various appropriate computing nodes or computing providing devices. According to the embodiment of the present disclosure, the computing provider side devices may be referred to as computing providers, which may correspond to various appropriate types of nodes or devices, such as base station devices, cloud computing devices, or any appropriate devices, as long as they can provide resources that can be used by specific applications for operation and calculation.

The computing consumer side can be a side in the communication network that uses the computing to execute various applications, such as AR/VR and Face Recognition. According to an embodiment of the present disclosure, a computing consumer side device may be referred to as a computing utilizer, which may be various appropriate devices capable of utilizing the computing, such as a terminal device, which may be a “user equipment” or a “UE”, and has the full range of its ordinary meaning.

According to the present disclosure, each of the computing scheduling management side device, computing provider side device and computing consumer side device can be implemented in various ways, such as hardware, firmware, software and the like. In one embodiment, each of the computing scheduling management side device, computing provider side device and computing consumer side device can be any kind of processing unit/function in the wireless communication system, and they can be realized individually or separately, or integrated with each other. As an example, the computing scheduling management side device, computing provider side device and computing consumer side device can perform corresponding functions or operations by separate devices respectively. As another example, at least two or even all of the computing scheduling management side device, computing provider side device and computing consumer side device can be implemented integratedly, for example, by a single device. For example, a device itself can provide computing, and/or operate with computing, and/or realize computing scheduling.

In operation, the computing provider informs the computing scheduling management side of the information about computing that the computing provider can provide, where the computing refer to the computing which can be provided by the computing provider and are shareable, and the computing scheduling management side can aggregate the obtained information about computing, for example, construct a computing native network in which devices providing computing are used as computing nodes, and appropriate computing allocation can be made for the computing consumer side according to the application requirements of the computing consumer side, so that the computing consumer side can access to the computing provider side and utilize the allocated computing to support application services. And the computing may also be increased by a new provider device, released by the original provider device, or released back into the computing native network after being utilized by the computing consumer side to complete the application, so that the computing can be scheduled again and the system execution can be optimized.

It should be pointed out that communication among the computing scheduling management side device, the providing side device, and the consumer side device can be implemented by means of any suitable signal, protocol, channel, path, form and the like known in wireless communication, as long as the computing related information, computing scheduling related information, and any other suitable data and the like can be safely transmitted. According to the present disclosure, the establishment of a computing native network, the scheduling of computing, etc. can be signaled via a specific signal, such as broadcast from a controller and/or a computing provider and/or a broadcast signal and/or a dedicated signal on a specific channel, which can take an appropriate form known in wireless communication and will not be described in detail here.

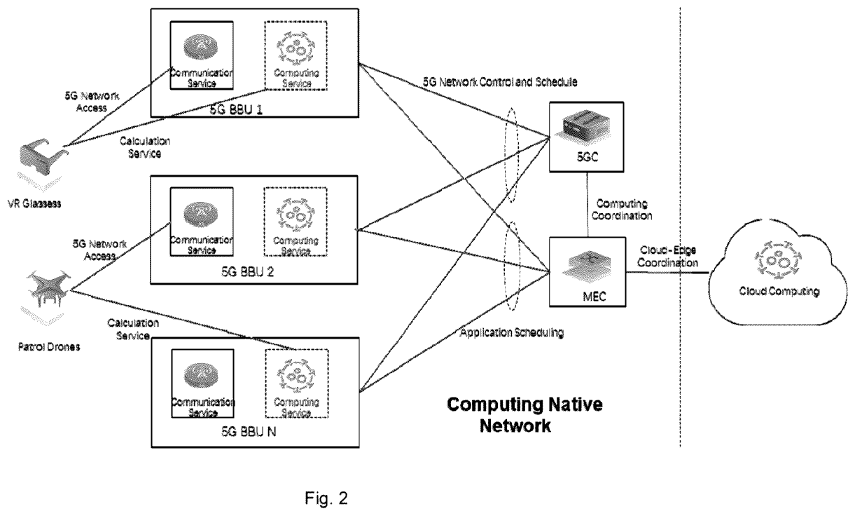

FIG. 2 illustrates an exemplary overall architecture of a computing scheduling scheme according to an embodiment of the present disclosure, which includes various network entity functions as follows:

VR glasses, patrol drones, etc., that correspond to devices that need to utilize computing to execute applications so as to operate or provide services, and can correspond to the computing consumer side.

Base station server: that can correspond to the computing provider side, and can provide basic 3GPP 5G RAN network services: increase/utilize temporary computing resource to provide computing services. For example, it can communicate with various terminal devices to provide network services, and can further provide computing for use.

MEC: that can correspond to the computing scheduling management side, which provides edge computing scheduling capability: cloud computing coordination and scheduling capability. In particular, it can obtain the status of cloud computing and realize appropriate scheduling of cloud computing. On the other hand, it can also obtain temporary computing resource provided by the base station server, integrate various temporary computing resource, and then allocate applications or terminal devices to various temporary computing resource.

5GC: that provides basic 5GC network services: network computing coordination service. In particular, it can assist in establishing network connection between the base station server and the user terminal, so that the terminal can utilize the computing provided by the base station server to perform operations. In particular, in some embodiments of the present disclosure, 5GC can also serve as a part of the computing scheduling management side, which can coordinate network computing. Particularly, in other embodiments of the present disclosure, 5GC can also serve as a part of the computing provider side, which can coordinate the application of computing between the base station server and the terminal.

In particular, each device in the system architecture can be implemented in various appropriate ways. As an example, MEC and 5GC may be implemented separately, or may be integrated. As another example, either MEC or 5GC can be integrated in the base station server or any other appropriate controller.

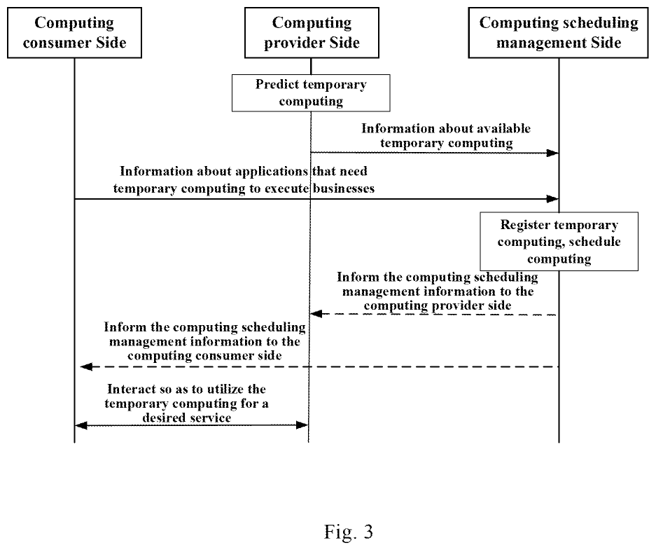

FIG. 3 illustrates a conceptual signaling diagram of temporary computing resource scheduling according to an embodiment of the present disclosure.

First, the computing provider side device determines or predicts the status of its own temporary computing resource, and when there exists temporary computing resource to share, provides information about the temporary computing resource to the computing scheduling manager.

Then, the computing controller receives this information, and registers or constructs the temporary computing resource into the computing native network. Here, optionally, after the registration is successful, the computing controller can also send confirmation information to the provider, for example, informing that the registration is successful.

In addition, the computing controller can also obtain information about the application requirement of the computing consumer side, such as from the computing consumer side or from other appropriate devices.

As a result, the computing controller performs computing scheduling based on the application requirement of the computing consumer side, and particularly allocates specific computing for the application requirement or deploys applications to specific computing nodes.

Then, the computing controller, when performing computing scheduling based on the application requirement, can inform the computing provider side and the consumer side of relevant information about the computing scheduling, so that the device on the computing consumer side can invoke the computing to execute related applications. It should be pointed out that this informing manner is only optional, and the computing consumer side and provider side can also obtain the computing scheduling conditions in other ways.

Here, optionally, if a consumer side device does not access to the network, for example, it is unable to communicate with the computing provider assigned to the device, the consumer side device accessing to the network can be implemented by the network controller, so that the consumer side device can communicate with the computing provider via the network, so that the consumer side device can invoke the computing to execute the application.

Then, if the temporary computing resource provided by the computing provider is no longer available, for example, the computing provider needs to use the computing to perform network service, the computing provider can send a request to the computing scheduling manager, that is, a request to revoke or withdraw resources. Upon receiving this request, the computing scheduling manager can exclude the corresponding temporary computing resource from the computing native network for scheduling, while the computing provider can use the released temporary computing resource to meet its network service requirement. Here, optionally, after the revocation is successful, the computing controller can also send confirmation information to the provider side, for example, informing that the revocation is successful.

In addition, after the computing consumer side has completed the application by using the allocated computing, the computing consumer side can also inform the control side of the completion information, so that the control side can recover the computing back into the computing native network for subsequent scheduling.

In addition, if the computing provider can provide new temporary computing resource, the computing registration and access to the computing native network can be performed as described above, so that the newly added temporary computing resource can also be used for scheduling.

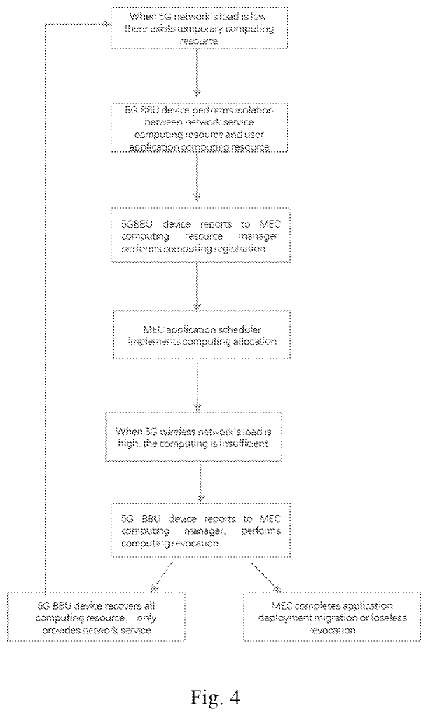

FIG. 4 illustrates an exemplary overall flowchart of computing resource scheduling according to an embodiment of the present disclosure. Among them, the flow of computing scheduling management is illustrated by taking 5G BBU as an example of the computing resource provider side device and an edge computing scheduling manager as an example of computing resource scheduling management side device.

Exemplary implementations of various embodiments of the present disclosure will be described below with reference to the drawings.

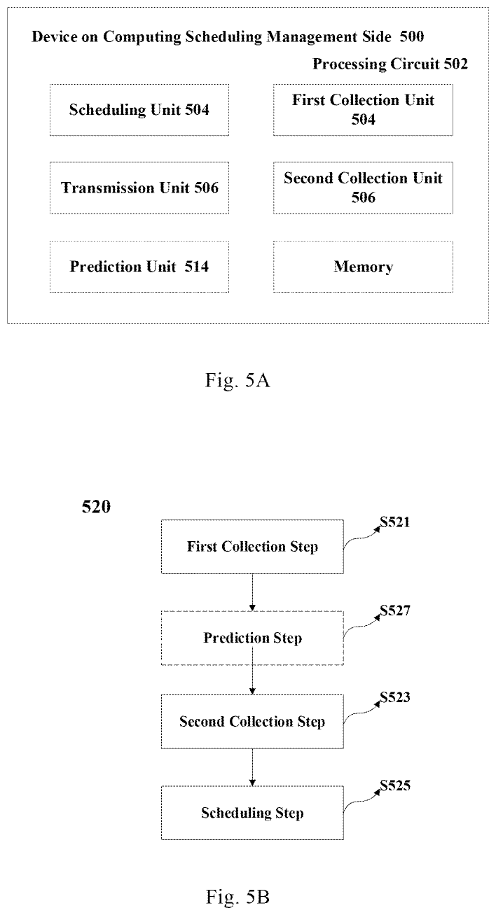

FIG. 5A illustrates a schematic block diagram of a computing scheduling management side device according to an embodiment of the present disclosure. The device 500 corresponds to a device on a computing scheduling management side in a wireless communication system, and includes a processing circuit 502 configured to collect computing related information, wherein the computing includes shareable computing that can be provided by a computing provider side: collect information about an application on a computing consumer side that needs to utilize the computing, and perform computing scheduling for the application based on the computing related information and the information about the application, wherein the information about the application includes application attribute information, and the computing scheduling for the application includes corresponding computing scheduling for the application based on the application attribute.

According to the embodiment of the present disclosure, the shareable computing provided by the computing provider side can also be called temporary computing resource. In particular, it can include other computing provided by the computing provider other than basic computing, wherein the basic computing indicates the computing required by the computing provider to meet the requirement of a specific application/business (e.g., basic application/business, necessary application/business, etc.) so as to ensure normal operation of basic applications on the computing provider side, and the basic computing is generally used by the computing provider itself, without being shared. Temporary computing resource can be provided to other devices/applications in the system for use when not being used by the computing provider itself, and can be released for its own application when need to be used by the computing provider itself. In this way, the working efficiency of the system can be improved on the premise of ensuring its own application service.

In particular, in the context of the present disclosure, the device on the computing provider side can realize both functions of providing application services and providing computing, and can realize both functions concurrently or switch between them, for example, the redundant computing can be shared while maintaining the basic application services. As an example, when the base station server in the wireless network can provide computing, the basic computing can correspond to the computing required by the base station to provide necessary communication/network services, or can also include the computing required by other necessary operations, so that the communication function of the base station can be guaranteed, and the computing after excluding the basic computing or even excluding specific redundant computing or standby computing from the total computing of the base station server can serve as the temporary computing resource. It should be pointed out that, as another example, all the computing provided by the computing provider can also be used as dynamic computing and can be shared with other users. Such a computing provider can be a specific device that provides computing, such as a dedicated processor, server, etc.

According to an embodiment of the present disclosure, the temporary computing resource can be any suitable computing, especially the computing available at a specific time in the future. Therefore, the temporary computing resource can be determined in various appropriate ways, especially predicted.

In some embodiments, the temporary computing resource can be predicted based on the information about operation condition of the computing provider side device. In particular, depending on functions realized by or services provided by the computing provider side device itself, the operation condition of the computing provider side device can be of various types, such as at least one of network communication conditions, service supply conditions, resource overhead conditions, etc. As an example, network communication conditions may include communication quality, communication load, etc., service supply conditions may include user access conditions, service user conditions, workload, etc., and resource overhead may include various resource utilization rates, work overhead, etc. It should be pointed out that the information used to predict the temporary computing resource can also be any other appropriate type of information or data, as long as it can reflect the computing utilization condition of the provider and can be used to determine or predict the shareable temporary computing resource. The determination/prediction of temporary computing resource will be further described below.

According to an embodiment of the present disclosure, the computing related information may include any appropriate information related to the computing, especially the temporary computing resource. In some embodiments, information that directly reflects the computing attributes may be included. For example, the computing related information may include at least one of the available time and available size of the temporary computing resource, the routing information of the computing provider, and may further include ID of the computing provider, etc. In particular, the prediction of temporary computing resource can be performed on the computing provider side, for example, the temporary computing resource on the network element side can be decided by the computing controller in the network element entity, and then information directly reflecting the attributes of the temporary computing resource can be sent to the computing scheduling management side. In other embodiments, the prediction of temporary computing resource can also be performed on the computing scheduling management side, and accordingly, the computing related information can contain any information that can be used to predict the temporary computing resource, such as the aforementioned information related to the operation condition of the computing provider, so that the computing scheduling management side can predict the temporary computing resource based on such information.

In some embodiments, the computing related information can be obtained by the computing provider and sent to the computing controller. For example, the computing provider itself can obtain information about its operation condition, and can send it as the computing related information, or can determine or predict the temporary computing resource based on this information, and send the conditions of temporary computing resource (for example, information about temporary computing resource attributes) to the computing controller as the computing related information. In other embodiments, the computing related information can be collected and sent by other devices in the system in a similar way.

According to embodiments of the present disclosure, the computing related information can be expressed in various appropriate ways. In some embodiments, for example, the information relevant to each computing node can be expressed in a vector form, including but not limited to ID of each node, the respective computing related information, and so on. Such information can be constructed during initialization of the computing native network, and can be updated during operation, for example, periodically, or updated when there happens any change in computing nodes, or updated upon the request from the computing scheduling management side or consumer side.

According to the embodiment of the present disclosure, the computing related information can be propogated in the system in various appropriate ways. As an example, the computing related information can be included and propogated by extending existing information or signaling, such as BGP (Border Gateway Protocol) signals, etc, for example, reserved bits in the signals can be utilized to include not only routing information, but also the computing related information. As another example, new information or signaling can be configured for transmitting the computing related information.

### Computing Prediction

The mechanism of computing prediction according to an embodiment of the present disclosure, especially that relating to temporary computing resource prediction, will be described below. Here, the predicted temporary computing resource especially refers to temporary computing resource in the future, especially the computing at a specific time or in a specific time period after the prediction operation. Prediction can be performed in various appropriate ways. In particular, based on the operation data, a future computing usage condition can be predicted, so that the computing that may be idle in the future can be determined.

According to the embodiment of the present disclosure, the relevant information about the operation condition of the computing provider side device can be information related to at least one of network communication conditions, service supply conditions, load conditions, resource overhead conditions, etc. on the computing provider side.

In some embodiments, the relevant information about the operation condition of the computing provider side device may include at least one of historical operation data and real-time operation data of the computing provider side device. In particular, historical operation data may include at least one of historical network communication conditions, historical service supply conditions, historical resource overhead conditions, etc., which may be historical operation records in a specific time period before prediction. Real-time operation state data can include at least one of network communication conditions, service supply conditions, resource overhead conditions, etc. when the computing provider is currently operating, and can be collected in real time when the computing provider is currently operating, for example, it can be collected in real time at a specific time or in a specific time period during the prediction.

According to the embodiment of the present disclosure, different types of operation data can be predicted and corresponding prediction results can be obtained. In some embodiments, prediction can be performed based on the historical operation data to obtain computing prediction on a large-scale time. In particular, the large-scale time may correspond to a relatively large time range, and based on the historical operation data, the computing status on large-scale time, such as the computing utilization status, can be predicted, so that any possible temporary computing resource can be determined on large-scale time, that is, the possible temporary computing resource in a relatively large time range in the future can be predicted, which is helpful to full utilization of temporary computing resource.

In other embodiments, additionally or alternatively, prediction can be made based on the real-time operation data to obtain computing prediction on a small-scale time. In particular, the small-scale time may correspond to a relatively small time range, and the computing status on the small-scale time, such as the computing utilization status, can be predicted based on the real-time operation data, so that any possible temporary computing resource can be determined on small-scale time, that is, the possible temporary computing resource in a relatively small time range in the future can be predicted, so that the short-term or even sudden computing utilization situation can be fully considered, and the predicted computing is accurate.

According to the embodiment of the present disclosure, prediction can also be performed using both historical data and real-time data. In one embodiment, the temporary computing resource can be predicted as follows: predicting a first temporary computing resource based on historical operation data of the computing provider side device; and updating the predicted first temporary computing resource based on the real-time operation data of the computing provider side device, as the temporary computing resource available from the computing provider side device. In particular, the updating operation can be performed in various appropriate ways, for example, the small-scale prediction result and the large-scale prediction result can be superimposed together, so that a comprehensive and fine computing prediction result can be obtained, and more accurate computing scheduling can be realized.

According to the embodiment of the present disclosure, the computing state decision, and then the computing prediction/determination, can be performed by any suitable entity. In some embodiments, the computing state decision and the computing source prediction/determination can be performed by the computing provider itself, such as the computing controller in the network element entity. In other embodiments, the computing state decision and the computing prediction/determination can be performed by other appropriate devices in the network, which can collect the information about the operation condition of the computing provider by monitoring the operation of the computing provider or from the computing provider, and then perform temporary computing resource prediction.

According to the embodiment of the present disclosure, the computing prediction can be performed by various methods, such as machine learning, neural network and other algorithms, and of course, other prediction methods known in the field can be employed, which will not be described in detail here.

According to the embodiment of the present disclosure, the temporary computing resource can be provided by the computing provider side in various appropriate ways. In particular, on the computing provider side, computing can be effectively isolated, for example, basic computing can be effectively separated from the temporary computing resource, so that even if the temporary computing resource is used by other applications, utilization of basic computing will not be affected, thereby ensuring the service quality of basic applications.

According to embodiments of the present disclosure, computing isolation can be implemented in various appropriate ways. In one embodiment, the temporary computing resource is set separately from the basic computing in a virtual way. As an example, the temporary computing resource can include the computing in a specific number of units set by a virtualization technology when it is determined that the computing is idle, and the temporary computing resource is isolated from the communication service computing used for basic communication services.

In this way, after the temporary computing resource is predicted and properly processed, the computing provider side or other appropriate entities can communicate with the computing scheduling management side to transfer the computing related information so as to realize computing scheduling.

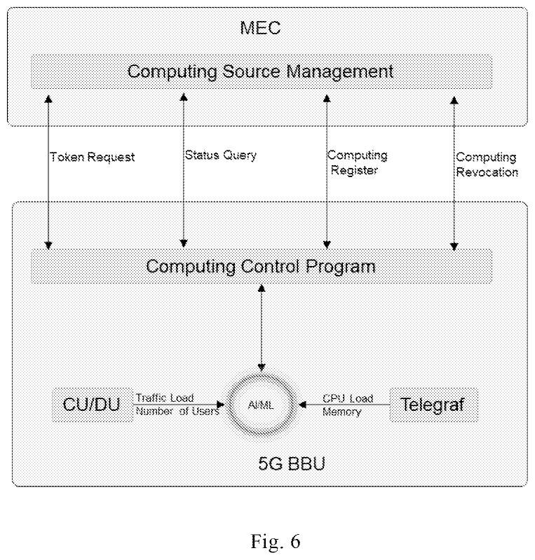

FIG. 6 illustrates an exemplary implementation of computing prediction according to an embodiment of the present disclosure. Among them, the computing prediction according to the embodiment of the present disclosure will be described by taking the intelligent decision of BBU computing state as an example. This decision process can be performed by the BBU itself or by other appropriate devices capable of communicating with the BBU.

On one hand, historical operation data of BBU can be collected, for example, historical time series data such as Traffic Load, number of user connections, PRB (physical resource block) utilization rate, CPU utilization rate and memory utilization rate, etc. on BBU in a specific time period (e.g., several weeks), and then the time series data analysis can be performed by various appropriate AI/ML (artificial intelligence/machine learning) algorithms, to predict the traffic, the number of user connections, the PRB utilization rate and CPU utilization rate in a specific time period (e.g, several minutes, several hours) in the future, and make the decision of computing state on a large scale time.

On the other hand, it is to further collect the real-time operation data of BBU, which can be the same type of data as the above-mentioned historical operation data, and use the same or different AI/ML algorithm to perform time series data analysis, update the predicted data, and make the decision of computing state on a small scale time. This can not only ensure full usage of BBU temporary computing resource, but also deal with instantaneous computing enhancement caused by traffic burst.

In this way, the computing state of each BBU can be accurately predicted by automatic iterative calculation of AI/ML algorithm, and then when the computing may be idle can be further obtained. As an example, considering holidays, weekends and working days comprehensively, it is possible to distinguish high busy BBU, medium busy BBU and low busy BBU, as well as busy BBU and idle BBU, so that it is possible to determine which BBU or BBUs can provide the temporary computing resource in a specific time period in the future.

Then, a virtualization technology, such as hypervisor technology, can be used to isolate the temporary computing resource from the communication service computing through the virtualizer, so as to ensure that the communication service is preferential and the service quality will not degrade. In this way, by abstracting the distributed BBU temporary computing resource, centralized scheduling control can be implemented to support dynamic management of BBU temporary computing resource. Moreover, in operation, by utilizing the BBU temporary computing resource, it can ensure that the network performance is not damaged, the network deployment, the network protocol, and the network service quality keep unchanged.

In particular, BBU computing is quantified with “CPU core” as a basic unit, CPU core can refer to CPU kernal, and the number of CPU cores can correspond to the number of CPU kernals. When it is judged that BBU contains the temporary computing resource which is not less than a certain number of “CPU cores”, it can be considered that BBU can provide shareable temporary computing resource and, such temporary computing resource can be separated from basic computing. The specific number can be an appropriate positive integer, for example, greater than or equal to 1 and less than or equal to N, where N is the total number of computing cores of the BBU. As an example, provide that the specific number is 4, when it is determined that BBU is idle, at least 4 cores can form actual computing, and a computing environment can be generated on the basis of 4 cores (or more) in the form of a virtual machine VM. For example, when there exist M>4 CPU cores of temporary computing resource, it can be considered that there are M temporary computing resources to share. Of course, depending on the specific application, business requirement, etc., BBU computing can also have other basic units, such as 2 CPU cores or other specific number of CPU cores, or any other appropriate basic computing unit.

Therefore, each BBU computing control program can interact with a temporary computing resource control program of an external MEC computing controller through operations such as Token request, computing registration (revocation), and status query, etc., so as to facilitate the scheduling of temporary computing resource. Here, the calculation control program can be associated with the computing provider side, and the external MEC computing controller can correspond to the computing scheduling management side.

### Computing Scheduling

According to the embodiment of the present disclosure, the temporary computing resource of the computing provider, after being predicted, can be informed to the computing controller in an appropriate way so as to perform temporary computing resource scheduling.

In some embodiments, the availability of temporary computing resource can be informed by computing availability information, for example, computing availability information can also be referred to as computing enabling information, which indicates that temporary computing resource on the computing provider side is available and can be registered on the computing scheduling management side so as to be scheduled. Here, the information can be provided by the computing provider side itself, or can be known by other devices and then informed to the computing scheduling management side.

This information can be represented in various appropriate ways. As an example, this information can be explicitly represented and sent, for example, it can be separately represented and sent separately from the computing related information. For example, this information can be expressed as a binary value, for example, 1 means that the computing is available and 0 means that the computing is not available. Alternatively, the information can be any preset value, as long as when sent, it can indicate that the computing is shareable. It should be pointed out that the computing availability information and the computering related information can be provided by the same device, for example, by the computing provider side itself, or by other devices. As yet another example, the computing availability information and the computering related information can be provided by different devices.

As yet another example, this information may be set as default or implicitly, for example, it may not be set separately, but is implicitly indicated by the computing related information. In particular, when the computing related information is sent, it means that the computing can be used for sharing, so that the computing related information itself can be used as the computing availability information, without explicitly providing separate availability information.

According to the embodiment of the present disclosure, the computing scheduling management side can manage or schedule the temporary computing resource as indicated by the relevant information about the application requirement, which can also refer to deploying the applications to the temporary computing resource. The relevant information of the application requirement here may include various appropriate information, such as the computing request, the relevant information about the required computing, and so on. Among them, the relevant information about the required computing can include the time, size and so on of the required computing. As an example, the computing request may not be included in the relevant information about the application requirement, for example, it may be sent separately. According to embodiments of the present disclosure, the scheduling or allocation of temporary computing resource can be performed in various appropriate ways.

In some embodiments, the temporary computing resource can be randomly allocated for applications. For example, for at least one given application, the available temporary computing resource can be randomly allocated to meet their application requirements.

In some embodiments, the allocation of computing resources can also consider the correlation with the applications, especially in the order from high correlation to low correlation, and particularly, the higher the correlation is, more preferentially the computing will be allocated to the application. Correlation can be measured by various factors. According to some embodiments, the correlation may depend on distance between a device executing the application and a device providing computing, such as physical distance, spatial distance, etc. The physical distance may include the physical distance between a provider providing computing and a terminal device executing the application, and the spatial distance may include distance between a provider providing computing and a terminal device executing the application in terms of communication, such as the length of communication path, the number of relays involved, etc. The closer the distance is, the stronger the correlation is. In this way, in the process of computing resource allocation, the computing can be allocated in order of distance from near to far, especially the computing providers who are close to the terminal device executing the application are preferentially considered, so that efficient resource utilization can be realized, and operation efficiency can be improved. According to some embodiments, the correlation can also depend on other factors, such as computing usage history of the application, in which the previously used computing has a high correlation, and the more times it is used, the higher the correlation is: or other appropriate factors. It should be pointed out that the correlation can also be preset, so that the computing can be allocated according to the preset correlation, for example, from high to low.

In some embodiments, priorities can be configured for applications, and the computing resources can be allocated for the applications in order of application priorities from high to low. For example, computing can be preferentially allocated for high-priority applications, for example, computing can be randomly selected from a computing native network or allocated according to correlation, as described above.

In some embodiments, priorities can also be configured for computing, particularly temporary computing resource, for example, mainly in consideration of its available time duration, available size, etc., in the future, so that the computing can be allocated further in consideration of the priority of computing. In some examples, when the computing information indicates that the computing will not be used for a long time in the future, it means that such computing is idle for a long time and can be used relatively stably, so it can be configured with high priority and can be used preferentially for high-priority applications. On the other hand, if the computing information indicates that the computing may not be used in a certain time in the future, it means that such computing may be revoked in the future and cannot be used relatively stably, so it can be set to a low priority and will be allocated later in the allocation process. As an example, high-priority computing can be allocated to high-priority applications and low-priority computing can be allocated to low-priority applications.

In other embodiments, the computing resource allocation can also be executed based on the category of application, etc. For example, applications can be classified, and the corresponding computing allocation can be performed for various applications, so as to better meet the application requirements. It should be pointed out that application classification can also be equivalent to setting priorities to some extent, for example, certain categories of applications can be set to have higher priorities. Moreover, the computing allocation for the application can also be performed as described above.

It should be pointed out that the aforementioned allocation of computing to applications can also be equivalent to, for a given computing, deploying applications to the computing. In particular, for a given computing, applications can be deployed depending on their attributes, such as application priority, correlation between applications and computing, application category, etc., and executed in a manner similar to that as described above, which will not be described in detail here.

According to the embodiment of the present disclosure, the computing resource provider side and the computing resource consumer side can perform operations based on the allocation of computing for applications. In particular, the computing resource consumer side can invoke the allocated computing of the computing resource provider side to execute its own applications or operations, provide services, and so on.

The computing resource provider side and computing resource consumer side can obtain relevant information about the allocation of computing for applications in various appropriate ways.

In some embodiments, after completing the allocation of computing for applications, the computing scheduling management side can store the relevant information in an appropriate location, which is intended to be invoked when the computing resource consumer side performs operations. For example, BBU and UE do not know the information about allocation of computing for applications. When UE looks for services, the information can be found through IP address or DNS settings, which can be dealt with at the application service layer, without caring about the specific allocation of computing for applications.

In other embodiments, additionally or alternatively, after the allocation of computing for applications is completed, the relevant information about the allocation of computing for applications can be sent to the computing resource provider side and the computing resource consumer side as the relevant information about computing scheduling, wherein the relevant information about computing scheduling can include information indicating the correspondence between computing and applications, such as which computing is intended to be allocated for which application or applications, the available size of the allocated computing, the available time of the allocated computing, etc., the relevant information about computing scheduling can be expressed in an appropriate form, such as a table, etc., and can be sent in an appropriate manner, such as broadcast in the system, or sent to the involved computing provider side device and computing consumer side device, etc., for example, as described above for the computing related information, which will not be described in detail here. Therefore, the computing resource consumer side can consider the status of computing associated therewith which is indicated in the relevant information about computing scheduling and execute applications/services by using the computing. Alternatively, the computing resource provider side may execute the application deployed thereto as indicated in the relevant information about computing scheduling. The signaling interaction between the computing resource consumer side and the computing resource provider side can be performed by any appropriate method known in the art, and will not be described in detail here.

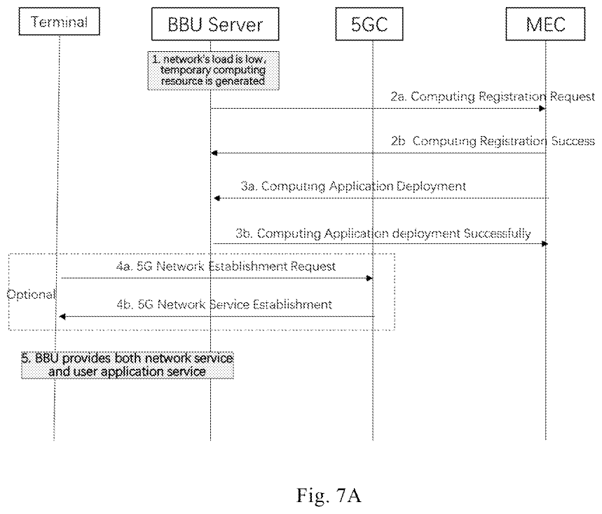

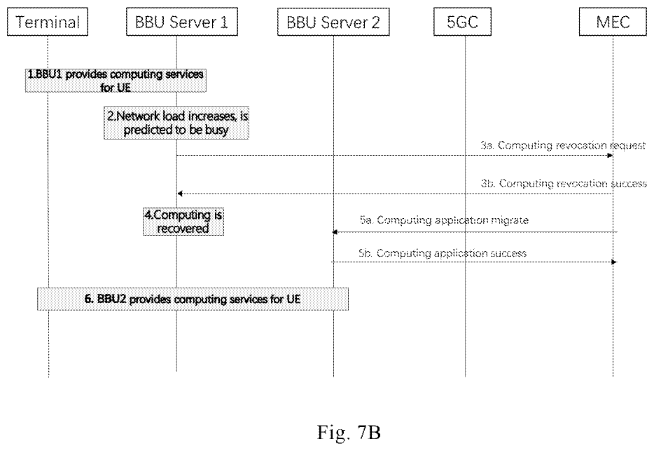

A schematic diagram of a computing scheduling process according to an embodiment of the present disclosure will be described below with reference to FIG. 7A. In particular, the computing scheduling process can include computing management and computing scheduling, where the computing management can include collecting temporary computing resource to be accepted in the computing native network, and the computing scheduling can include allocating computing according to application requirement, or deploying applications in the computing native network, especially computing nodes in the computing native network.

As an example of the device on the computing scheduling management side, the edge computing controller in a MEC platform mainly provides functions such as edge computing management and computing scheduling. Its management objects are fixed computing nodes and temporary computing nodes, and its service objects are various 5G edge applications and wireless BBU services.

When the wireless BBU's load is low, BBU uses a virtualization technology to isolate idle resources, and informs the computing controller of MEC platform through messages. The edge computing platform automatically accepts the temporary computing resource of BBU as temporary computing nodes, which can be provided to edge applications for use, thus improving the overall utilization rate of network resources.

In this case, the usage process for computing native services is shown in FIG. 7A:

Step 1: Through data monitoring for network and application, etc., or through the intelligent decision algorithm, it is decided that the network load is low or the service load is low, and the temporary computing resource can be used for other services. The decision operation here can be performed as described above.

Steps 2a˜ 2b: BBU server sends the status of its own computing resource to MEC, and MEC completes the computing acceptance and registration, and replies with a success message. Among them, the registration request may include the computing related information, or may include both of the computing related information and the computing available information, or may also include other necessary indication information. In addition, the reply of the success message is optional. For example, the success message can be not replied, but the subsequent relevant information about the allocation of computing for application can be directly sent.

Steps 3a˜ 3b: MEC completes the allocation of computing for application. Here, the transmission of information that indicates the allocation of computing for application is successful is also optional. For example, if no feedback is received within a certain period of time, it is considered that the allocation of computing for application is successful, and then the allocation status of computing for application is recorded.

Steps 4a-4b: If the terminal does not access to the network, it needs to complete the access to 5G network, so as to realize the network service. Access to the 5G network can be performed in various appropriate ways known in the art, and will not be described in detail here. It should be noted that this step is optional. If the terminal has successfully accessed to the network, this step would not be performed.

Step 5: The computing application on BBU can provide application services for the terminal. For example, the terminal can invoke the computing allocated thereto so as to execute an application.

It should be pointed out that the above-mentioned process can be equally applied to a case after the terminal has utilized the computing allocated thereto so as to execute the application. In particular, after the terminal completes the operation, for example after step 5, the MEC can be informed of the case of operation completion, so that the MEC can recover the computing previously allocated to the terminal back to the computing native network, so that the computing can be subsequently scheduled, as in the aforementioned steps 3a to 5. Alternatively, if multiple terminal applications are deployed for a computing, the computing would be released for subsequent computing scheduling after the multiple terminal applications have been completed.

### Computing Revocation

According to the embodiment of the present disclosure, the computing sharing can also be disabled or revoked. In particular, when the temporary computing resource is no longer available due to other demands, for example, the workload of the computing provider itself increases and more resources are needed, the computing provider would use the temporary computing resource by itself to perform operations or provide services without sharing. In this case, the computing provider can send a message to the control side to inform the computing scheduling management side of the disabling situation.

In some embodiments, the computing provider can provide the temporary computing resource revocation information to the computing scheduling management side, and the computing scheduling management side device can terminate the scheduling of the temporary computing resource indicated by the revocation information, after obtaining the revocation information from the computing provider side device, and inform the temporary computing resource provider of the termination indication. In some embodiments, it should be pointed out that it is not necessary for the computing scheduling management side to notify the termination indication. In some examples, after the computing provider informs the computing scheduling management side of the revocation information, the computing provider is ready to reuse its resources to perform its self-needed operations or other specific operations. In some other examples, after notifying the revocation information to the computing resource scheduling management side, if no termination indication is received from the computing resource scheduling management side after a certain time, the computing resource provider side is ready to reuse its resources to perform its basic network service operations.

In some embodiments, the revocation information can be set in various appropriate ways. As an example, the revocation information may include relevant information about time, size, etc. of the temporary computing resource that is expected to be revoked. In particular, the temporary computing resource that is expected to be revoked may be at least a part of the temporary computing resource, such as all or a part thereof. Here, in some embodiments, the computing revocation request may include information about the temporary computing resource release ratio, which indicates the ratio of the temporary computing resource expected to be released to the provided temporary computing resource. As another example, the revocation message may also include ID of the supplier that provides the computing to be revoked, and so on.

According to the embodiment of the present disclosure, the release of temporary computing resources can be carried out in an appropriate manner. In some embodiments, if the computing is currently being used by other applications, the computing would not be released until the other applications complete the operation. For example, after the computing has been utilized by other applications, the other applications can report such case to the computing scheduling manager, and then the computing scheduling manager will inform the computing provider of the information that the computing can be released. In other embodiments, an allowable time threshold for temporary computing release can be set in advance, and if a revocation success notification from the computing scheduling management side has not been received after the time threshold has passed, the computing provider side will automatically recover the computing. For example, if the computing is currently used by other applications, and the time during which the computing is to be used is within the allowable time threshold, the computing can be released after other applications complete the operation, otherwise, the computing will be released immediately, without allowing other applications to reuse the computing. In still other embodiments, the computing can be released immediately, and the utilization of other applications can be stopped, regardless of the execution of other applications.

According to the embodiment of the present disclosure, the above release may also consider the priorities of applications. According to some embodiments, if the priority of the application to be executed by the computing provider is higher, for example, higher than that of the application currently using temporary computing resource, the usage of the current temporary computing resource can be stopped immediately. If the priority of the application to be executed by the computing provider is low, for example, lower than the application currently using temporary computing resource, the currently used temporary computing resource would not be released until waiting for the usage of the current temporary computing resource to end, and then be released to the computing provider for executing the application.

According to the embodiment of the present disclosure, in the computing revocation/termination operation, for an application to which the revoked computing is expected to be allocated, the computing scheduling management side can continue to allocate appropriate computing for the application, which can be regarded as migrating the application to other available computing nodes, such operations can also be referred to as application migration, computing adjustment, dynamic computing scheduling, and the like. This will be further described below.

A schematic diagram of a computing termination process according to an embodiment of the present disclosure will be described below with reference to FIG. 7B. Particularly, when the wireless BBU's load is high, the BBU informs the computing controller of the MEC platform via messages, and the controller migrates the application on the BBU node to other nodes, and returns the occupied temporary computing to the wireless side, so as to meet the wireless service under resource constraints at this time, thus achieving an effect of intelligent balance adjustment of wireless computing.

The process of computing native service termination is shown in FIG. 7B.

Step 1: BBU1 server provides computing service for the terminal.

Step 2: The load of BBU1 server increases, and the intelligent algorithm predicts that it is busy.

Steps 3a-3b: BBU1 server initiates the computing revocation request, and MEC confirms the temporary resource can be released. Here, optionally, step 3b may not be executed, that is, confirmation information of successful revocation may not be sent.

Step 4: BBU1 server completes temporary computing release.

Steps 5a-5b: MEC migrates the application previously deployed in BBU1 server to BBU2 server. This operation is also equivalent to re-allocating computing for applications previously allocated in BBU1 server. Here, the transmission of migration success information is also optional. As an alternative, successful computing scheduling of BBU2 implies the successful application migration.

Step 6: BBU2 server provides computing service for the terminal. Here, although not shown, BBU2 and the UE may already know information such as computing availability of the applications. For example, both the BBU2 and the UE can be informed of the computing scheduling status, so that the BBU2 can provide computing services for the UE.

### Application Migration

An exemplary implementation of application migration according to an embodiment of the present disclosure will be described below. In the context of the present disclosure, application migration can mean that during operation, a specific application can migrate between different computing nodes in the computing native network according to state change of the application or computing, or may be equivalent to adjusting the computing allocation for the application. Specifically, the computing can be allocated for the application through the computing scheduling scheme according to the present disclosure, and then during operation, the computing allocation for the application can be dynamically adjusted according to the change of the computing or the application. Application migration can be performed when the state of computing or application changes, such as computing addition, computing revocation, temporary computing release, etc. According to embodiments of the present disclosure, application migration may be performed in association with or as part of the aforementioned computing scheduling.

At present, in order to ensure the usability of the edge application and reduce extra expenses caused by edge application migration, when the edge application is deployed, only when in the edge computing platform, the fixed computing is tight and the dynamic nodes have enough computing, a process of occupying the computing resources of the dynamic nodes would be triggered, and such a process is mainly controlled by the application intelligent scheduling module of the edge computing platform. The application migration service is mainly responsible for application-related migration operations, including the contraction and expansion of application POD functional units, the overall migration and release of applications. Due to the particularity of dynamic resource pool, its computing resources may be reoccupied by BBU at any time, and edge applications deployed on dynamic resource pool will inevitably face the problem of application migration.

In view of this, the present disclosure proposes an improved application migration scheme, in particular, setting allocation relationship between a specific type of application and a specific type of computing, and performing application migration or computing allocation adjustment according to the allocation relationship between the specific type of application and the specific type of computing even when the computing resources in the computing native network change. Among them, applications can be classified based on application attributes, which can include at least one of application priority, application importance, etc. For example, applications can be classified into high-priority applications or high-importance applications, and low-priority applications or low-importance applications. In addition, computing resources can also be classified accordingly, for example, depending on the stability of computing resources, it can be classified into high stable computing and low stable computing.

In particular, the allocation relationship can be preset as follows: it is expected to deploy high-priority applications or high-importance applications to high-stable computing, and it is expected to deploy low-priority applications or low-importance applications to low-stable computing, so that in operation, even if the computing change occurs, application migration or computing allocation can still be carried out according to such allocation relationship, especially, high-priority applications or high-importance applications can be anchored to high-stable computing, so that the stable execution of high-priority or high-importance applications can be ensured preferentially, and even if application migration occurs, the system performance can be substantially maintained, so as to optimize the use of computing to execute application services without damaging network services and realize lossless migration of application services.

According to the embodiment of the present disclosure, applications can be classified into a basic application set and an extended application set. Among them, the basic application set can also be referred to as the minimum capacity set, which contains applications necessary to meet normal or basic operation requirements, and can correspond to high-priority or high-importance applications, and the computing should preferentially serve the operation and execution of applications in such application set. The extended application set can refer to non-essential applications or low-priority applications, which can be dynamically adjusted according to computing native network system state. For example, the basic application set corresponds to a part that can provide basic or necessary edge application services, and the extended application set corresponds to a part which can provide extended edge application services other than the basic edge application services.

According to an embodiment of the present disclosure, the partition of application set can be set in advance. For example, the partition can be set when the system is initialized, and remains fixed in the application process. This can be referred to as static application set setting. According to another embodiment of the present disclosure, the partition of application set can be dynamically set. For example, during the system operation, the partition of application set can be dynamically adjusted according to changes of service tasks executed.

According to the embodiment of the present disclosure, computing resources can be partitioned into static computing (which can be referred to as fixed computing) and dynamic computing (which can also be referred to as extensible computing), wherein the static computing can correspond to high-stable computing, preferentially available for high-priority or high-importance applications, and the dynamic computing can correspond to low-stable computing, which can be dynamically provided by computing nodes in a computing native network and can be used for low-priority or low-importance applications. In some embodiments, when the computing changes during operation, it is to preferentially deploy high-priority or high-importance applications to the static computing, while deploy low-priority or low-importance applications to the dynamic computing, so that even if the computing changes, the high-priority or high-importance applications still run with stable computing and are basically unaffected, the basic application requirements still can be met and the application performance of the system can be maintained better.

The computing can be partitioned as described above, for example, the temporary computing resource can be estimated or predicted according to the running state of the computing provider, and then partitioned. As another example, the computing can also be partitioned according to specific rules, such as according to a preset ratio or according to historical experience. Here, both static computing and dynamic computing can be obtained from the temporary computing resource provided by the computing provider. Alternatively, the static computing can be provided by the computing scheduling management side device itself or its associated computing library, while the dynamic computing can be provided by the temporary computing resource, which will not be described in detail here.

In particular, in some embodiments, the processing circuit of the computing scheduling management side device is further configured to: deploy applications in the minimum application set to a fixed computing node under the condition that the computing of the fixed computing node can serve at least some applications in the minimum application set. According to the embodiment of the present disclosure, the extended application set can be deployed to dynamic resources. In some embodiments, the processing circuit of the computing scheduling management side device is further configured to use a dynamic computing node to serve the extended application when the temporary computing resource provided by the dynamic computing node is available.

According to the embodiment of the present disclosure, the application deployment in each of the fixed computing node and the dynamic computing node can be performed in various appropriate ways. In some embodiments, it can be performed based on the priority of the application. In particular, the processing circuit of the computing scheduling management side device is further configured to: when the temporary computing resource provided by the dynamic computing node is available, apply the available temporary computing resource to the applications in the extended application set in order of priorities of the applications from high to low. Furthermore, particularly, in some embodiments, high-priority dynamic computing nodes can be allocated to high-priority extended applications. In some embodiments, the deployment of applications in fixed computing nodes can also be performed based on priority, which is similar to that described above and will not be described in detail here.

An exemplary implementation of application migration according to an embodiment of the present disclosure will be described below.

Before deployment, the edge applications can be partitioned into the minimum capacity set and the extended capacity set. Ideally, the minimum capacity set should be deployed to a fixed resource pool and the extended capacity set should be deployed to a dynamic resource pool, as far as possible. In this way, even in the worst case, that is, the dynamic resource nodes are forcibly released, and the fixed resource nodes do not have enough resources to support the extended capacity set of the edge applications, the edge applications still have certain service capacities to ensure its availability.

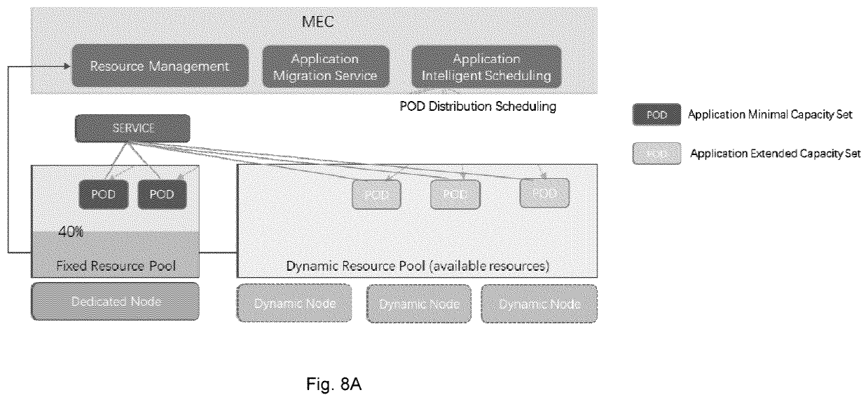

When the edge application is deployed, the application intelligent scheduling module first checks whether the fixed resource nodes meet the conditions for scheduling the resource pool, and concurrently checks whether the dynamic resource pool has enough resources. If the conditions are met concurrently, the application intelligent scheduling module deploys and anchors the minimum capacity set of the edge application to the fixed resource pool: then deploys the extended capacity set of applications to the dynamic resource pool. The final deployment effect of the edge applications in an ideal situation is shown in FIG. 8A.

When all dynamic resource pools have been forcibly released, in a case that the computing in the fixed resource pool allows, the application intelligent scheduling module first invokes the application migration service to implement regeneration of the extended capacity set in the fixed resource pool, and then destroys the extended capacity set in the dynamic resource pool, as shown in FIG. 8B. When the BBU server is idle and returns to the dynamic resource pool, the application intelligent scheduling module re-schedules the extended capacity set of the edge applications to the dynamic resource pool.

In the whole process, through the anchoring deployment of the minimum capacity set of edge applications and the tidal deployment of the extended capacity set, the minimum capacity set of edge applications always runs in the fixed resource pool, providing the most basic services, while the extended capacity set carries out tidal migration according to the change of resources, so as to realize the smooth deviation of computing occupation and lossless migration of functions between the fixed resource pool and the dynamic resource pool.

Some embodiments of application migration according to the embodiments of the present disclosure will be described below, especially those related to application migration in non-ideal situations. In particular, in an ideal situation, fixed resources are allocated for the minimum application set and dynamic resources are allocated for the extended application set. However, in the non-ideal situation, when the computing may not meet the application requirements, the initial allocation of computing for application may not be realized as in the ideal situation, so in the operation, the allocation of computing resources can be adjusted as far as possible to migrate the application to its expected adaptive computing, especially migrate the high-priority or high-importance application to the high-stable computing resources to optimize its operation to meet its requirements.

According to the embodiment of the present disclosure, the non-ideal situation can refer to a case that the consumption of fixed resources and dynamic resources are uncertain, in this case, it is necessary to give priority to the computing guarantee for high-priority or high-importance applications, such as giving priority to the resource utilization of the minimum capacity set, and then considering the resource utilization of the extended function set.

A first embodiment of application migration according to the present disclosure under a non-ideal situation will be described below. Although it is expected to deploy dynamic resources for the extended application set, when no dynamic resources are available, fixed computing nodes can be used to serve the extended applications. During operation, the computing allocation for the extended applications can be adjusted according to the changes of computing resources, that is, the migration of basic applications and/or extended applications can be realized.

According to the first embodiment of the present disclosure, an extended application can be deployed to a fixed computing, and the fixed computing corresponding to the extended application can be used for a basic application if necessary. For example, when the Edge application is built or initialized, if the temporary computing resource provided by a dynamic computing node is not available, the extended application will be deployed in a fixed resource pool, that is to say, the extended application will occupy the resources originally belonging to the basic application, and in operation, if the situation of the basic application changes, for example, additional basic applications need to use resources or the basic application needs additional resources to operate, but there are no available resources in the dynamic resource pool, the basic application will occupy the fixed resources previously allocated to the extended application. In particular, the basic application is migrated to the fixed resource previously allocated to the extended application, and utilize the fixed resource to operate, while the extended application will stop operating. In the implementation of stopping the extended application, the extended application can stop immediately, or stop after a certain time, or wait for the extended application to complete the operation and then stop, as mentioned above, which will not be described in detail here.

In some embodiments, in the case where a plurality of extended applications are deployed to a fixed computing, if the basic application requires the fixed computing corresponding to at least one extended application, the fixed computing to be occupied can be randomly selected. In other embodiments, when a plurality of extended applications are deployed in a fixed computing, the computing applied to each extended application can be collected and applied to the basic application in order of of priorities of the extended applications from low to high. In particular, when the fixed resources previously allocated to the extended application need to be occupied, the computing resources for the extended application with low priority are preferentially occupied, and then the computing resources for the extended application with increasing priorities are gradually occupied.

Furthermore, according to the embodiment of the present disclosure, if available dynamic resources appear in the dynamic resource pool during the operation, the extended application can be migrated from the fixed resources to the dynamic resource pool, for example, in a random manner or according to the priority. In particular, when the dynamic computing is available, the extended application with high priority is preferentially migrated to the dynamic computing, and then the migration is carried out in order of priorities of the extended applications from high to low.

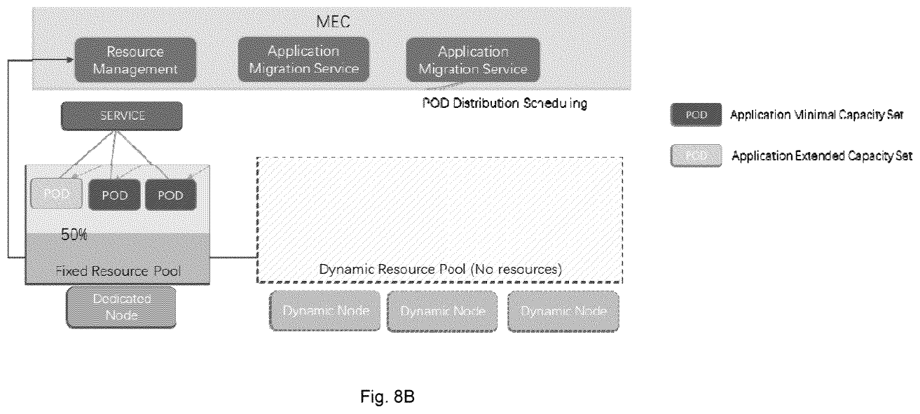

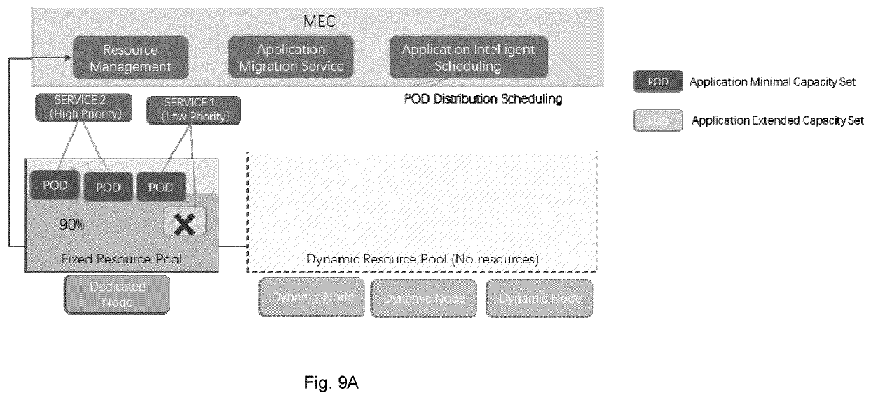

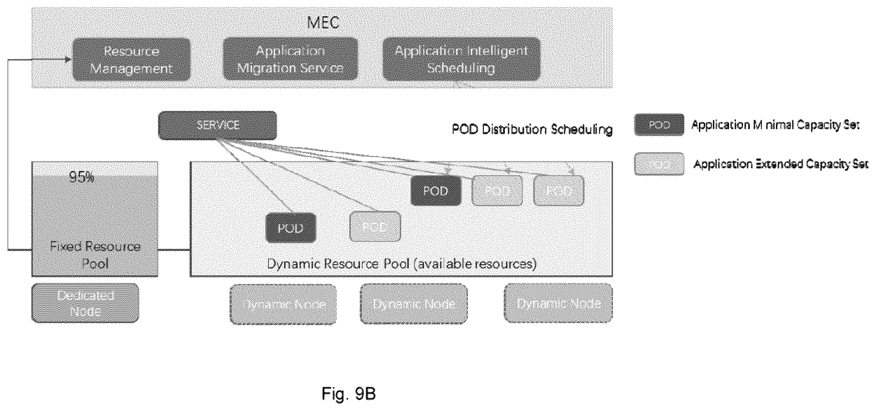

An exemplary implementation of application migration in a non-ideal scenario according to an embodiment of the present disclosure will be described below, as shown in FIG. 9A. In this non-ideal scenario, the edge application initially only occupies the fixed computing nodes.

When the edge application is deployed, if there does not exit any computing in the dynamic resource pool, the application intelligent scheduling module will deploy the minimum capacity set and the extended capacity set of the applications to the fixed resource pool concurrently, just like the traditional deployment scheme. The lossless migration in this scenario mainly belongs to the tidal migration of the extended capacity set of the edge applications between the fixed resource pool and the dynamic resource pool.

In order to cooperate with the anchoring deployment of the minimum capacity set of edge applications, edge applications need to be configured with corresponding application priorities, when the computing of the fixed resource pool is insufficient to deploy the minimum capacity set of applications, according to the priorities of edge applications, starting from an application with the lowest priority, the extended capacity set of low-priority edge applications will be expelled, and the released resources will be utilized to deploy the minimum capacity set of high-priority applications.

With the BBU server's load becoming low, the application intelligent scheduling module finds that new computing is added to the dynamic resource pool, and immediately schedules the extended capacity set of the edge applications to the dynamic resource pool in order of the priorities of the edge applications from high to low.

The second exemplary embodiment of application migration according to the present disclosure will be described below. In particular, although it is expected to deploy fixed resources for the basic application set, in the case that no fixed resources are available or the fixed resources are insufficient to carry all basic application sets, dynamic computing nodes can be used to serve the basic applications. In operation, the computing allocation for basic applications can be adjusted according to the change of computing resources, that is, the migration of basic applications and/or extended applications can be realized.

According to the embodiment of the present disclosure, it is possible to, for example, deploy the basic application to the dynamic computing and migrate the basic application to the fixed computing when the fixed computing is available, thereby giving priority to ensuring the resource utilization of the basic application during operation. Particularly, when the Edge application is built or initialized, if the temporary computing resource provided by the fixed computing node is unavailable, the basic application will be deployed to the dynamic resource pool, while in operation, if the temporary computing resource provided by the fixed computing node is available, the basic application will migrate to the fixed computing. Such an embodiment may correspond to a non-ideal scenario in which the edge application initially only occupies the resources of the dynamic computing node.

According to the embodiment of the present disclosure, when a plurality of basic applications are deployed in the dynamic computing, and when the fixed computing is available, the basic applications can be migrated from the dynamic computing to the fixed computing in order of priorities of the basic applications from high to low. Particularly, when fixed computing is available, the basic application with the highest priority will be migrated first, and then the basic application with decreasing priority will be migrated.

According to the embodiment of the present disclosure, in the case that the dynamic computing arranged for the basic application is no longer available, but the basic application cannot be migrated to the fixed computing, the basic application can be appropriately handled, including but not limited to, at least abandoning the basic application or applying the dynamic computing applied to the extended application to the basic application. In particular, in the latter case, the basic application will occupy other dynamic resources allocated to the extended application. In particular, the basic application is migrated to other dynamic resources allocated to the extended application, and then utilizes the dynamic resources to operate, while the previous extended application will stop operating. In the implementation of stopping the extended application, the extended application can stop immediately, or stop after a certain time, or wait for the extended application to complete its operation and then operate, which will not be described in detail here.

In this disclosure, the occupation of dynamic resources by basic applications can be carried out in various appropriate ways. For example, the dynamic resources can be occupied randomly or based on priority. In some embodiments, when a plurality of extended applications are deployed to dynamic computing, if the basic application needs the dynamic computing corresponding to at least one extended application, the dynamic computing to be occupied can be randomly selected. In other embodiments, the computing can be allocated in order of the priorities of basic applications from high to low, particularly, the basic applications with high priority preferentially occupy resources. In still other embodiments, when a plurality of extended applications are deployed to dynamic computing, the computing applied to each extended application is obtained in order of priorities of the extended applications from low to high and then applied to the basic application. In particular, when dynamic resources previously allocated to extended applications need to be occupied, the computing resources of extended applications with low priority are preferentially occupied, and then the computing resources of extended applications with increasing priority are gradually occupied.

In still other embodiments, in the application migration operation, the priority of the basic application can also be increased to help the application migration. Particularly, in the case that the dynamic computing allocated for the basic application is no longer available, but the basic application cannot be migrated to the fixed computing, the priority of the application can be increased to be higher than that of the extended application, and the computing occupied by the extended application with low priority can be allocated for the basic application with high priority.

An example of application migration in a non-ideal scenario according to an embodiment of the present disclosure will be described below, as shown in FIG. 9B. In this non-ideal scenario, the edge application initially only occupies a dynamic computing node.

When the fixed resource pool does not have computing enough to deploy the minimum capacity set of new edge applications, and the priorities of the new edge application are not high enough to drive away the extended capacity set of other edge applications, but the dynamic resource pool has enough computing, the application intelligent scheduling module can only temporarily deploy the edge applications as a whole to the dynamic resource pool. The lossless migration in this scenario involves the fixed resource pool regression for the minimum capacity set of edge applications and the tidal migration of the extended capacity set.

Subsequentially, if the fixed resource pool has enough resources to deploy the minimum capacity set of the edge applications due to computing expansion or other edge applications exiting, the application intelligent scheduling module will immediately schedule and anchor its minimum capacity set to the fixed resource pool.

If the minimum capacity set of the edge application in the dynamic resource pool has not been regressed to the fixed resource pool, the dynamic resource pool will be released by BBU, then the intelligent scheduling module will destroy the edge application, and continuously monitor the computing of the fixed resource pool and the dynamic resource pool, and the application will be deployed when the conditions are met.

Another optional strategy is that the intelligent scheduling module temporarily increase the priority of the current edge application, so as to drive away the extended capacity set of other applications and give priority to ensuring the resource requirement that the minimum capacity set of the current edge application regresses to the fixed resource pool.

In short, the lossless migration of edge computing applications depends on the partition of the minimum capacity set and the extended capacity set of edge applications, and can be realized through the tidal migration scheduling process between resource pools.

The device on the computing scheduling management side can be realized in various ways. In one example, the device for the computing scheduling management side according to the present disclosure may include units for performing the operations performed by the processing circuit as described above.

As shown in FIG. 5A, the processing circuit 502 may include a first collection unit 504 configured to collect computing related information, wherein the computing includes shareable computing that can be provided by a computing provider side: a second collection unit 506 configured to collect information about an application on a computing consumer side that needs to utilize the computing, and a scheduling unit 508 configured to perform computing scheduling for the application based on the computing related information and the information about the application, wherein the information about the application includes application attribute information, and the computing scheduling for the application includes corresponding computing scheduling for the application based on the application attribute. Here, it should be pointed out that the first collection unit and the second collection unit can be realized separately or combined into a single collection unit.

In some embodiments, the processing circuit 502 may further include a transmission unit 510 configured to inform at least one of the computing provider side and the consumer side of relevant information about the computing scheduling, so that an application on the computing utilizing side can provide services by using the computing indicated in the relevant information about the computing scheduling.

In some embodiments, optionally, the processing circuit 502 may further include a prediction unit 512 configured to predict the shareable computing by: predicting a first temporary computing resource based on historical operation data on the computing provider side; and updating the predicted first temporary computing resource based on real-time operation data on the computing provider side, as the temporary computing resource available from the computing provider side device. It should be pointed out that the prediction unit is optional, and the prediction of temporary computing resource can be performed by the resource provider or other devices.

In some embodiments, the scheduling unit 508 may be configured to implement computing resource allocation for at least one of a basic application and an extended application based on priority of the application, wherein the higher the priority of the application is, more preferentially the computing is allocated for the application.

In some embodiments, the scheduling unit 508 may be configured to preferentially deploy fixed computing for a basic application, and/or preferentially deploy dynamic computing for an extended application.

In some embodiments, the scheduling unit 508 may be configured to deploy the extended application to a fixed computing, and use the fixed computing corresponding to the extended application for the basic application, when the basic application requires.

In some embodiments, the scheduling unit 508 may be configured to, when a plurality of extended applications are deployed in a fixed computing, collect the computing applied to each extended application for applying to the basic application in order of of priorities of the extended applications from low to high.

In some embodiments, the scheduling unit 508 may be configured to migrate an extended application from the fixed computing to the dynamic computing when the dynamic computing is available.

In some embodiments, the scheduling unit 508 may be configured to, when the dynamic computing is available, migrate respective extended applications to the dynamic computing in order of priorities of the extended applications from high to low.

In some embodiments, the scheduling unit 508 may be configured to deploy the basic application to the dynamic computing, and migrate the basic application to the fixed computing when the fixed computing is available.

In some embodiments, the scheduling unit 508 may be configured to, when a plurality of basic applications are deployed in dynamic computing and fixed computing is available, migrate basic applications from the dynamic computing to the fixed computing in order of priorities of basic applications from low to high.

In some embodiments, the scheduling unit 508 may be configured to, in the case that the dynamic computing arranged for the basic application is no longer available, but the basic application cannot be migrated to the fixed computing, at least abandon the basic application or apply the dynamic computing applied to the extended application to the basic application.

In some embodiments, the scheduling unit 508 may be configured to, in the case that the dynamic computing allocated for the basic application is no longer available, but the basic application cannot be migrated to the fixed computing, increase the priority of the application to be higher than that of the extended application, and deploy the computing which has been occupied by the extended application with low priority to the basic application with high priority.

It should be noted that such collection unit and transmission unit can be combined into a communication unit for receiving and transmitting operations, and other information can also be transmitted to and received from a requester or other entity in the system.

It should be noted that although these units are shown in the processing circuit 502, this is only exemplary, and at least one of these units may be outside the processing circuit or even outside the service provider. The above-mentioned units are only logical modules partitioned according to their specific functions, instead of limiting their specific implementation. For example, these units, the processing circuit and even the service provider can be implemented in software, hardware or a combination of software and hardware. In actual implementation, the above units can be realized as separate physical entities, or can also be realized by a single entity (for example, a processor (CPU or DSP, etc.), an integrated circuit, etc.). In addition, the above-mentioned units are shown by dotted lines in the drawings, indicating that these units may not be included in the processing circuit, for example, outside the processing circuit, or their functions may be provided by other devices, or even may not actually exist, and the operations/functions they realize may be realized by the processing circuit itself.

It should be understood that FIG. 5A is only a schematic structural configuration of the device for computing scheduling management, and alternatively, the computing scheduling manager may also include other components not shown, such as a memory, a radio frequency link, a baseband processing unit, a network interface, a controller, and the like. The processing circuit may be associated with a memory and/or an antenna. For example, the processing circuit can be directly or indirectly connected to the memory (for example, other components may be interposed therebetween) to access data. As another example, the processing circuit can be directly or indirectly connected to the antenna to send information and receive requests/instructions via the transmission unit.

The memory can store various kinds of information, such as relevant information about model training and model evaluation generated by the processing circuit 502, programs and data for the operation of the service provider, data to be transmitted by the service provider, etc. The memory can also be located in the computing scheduling manager but outside the processing circuit, or even outside the computing scheduling manager. The memory can be volatile memory and/or nonvolatile memory. For example, the memory may include, but not limited to, random access memory (RAM), dynamic random access memory (DRAM), static random access memory (SRAM), read only memory (ROM) and flash memory.

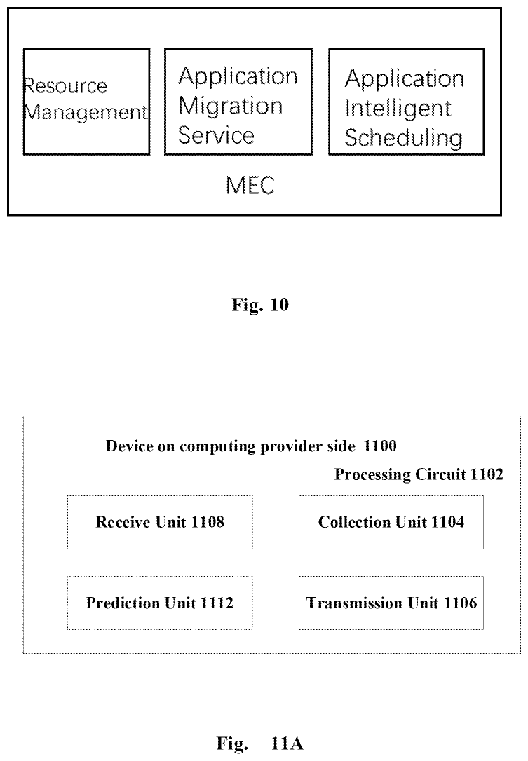

FIG. 10 illustrates an exemplary implementation of MEC according to an embodiment of the present disclosure, which includes the following modules to realize corresponding functions.

Computing management: BBU temporary computing resource management and revocation management.

Application migration service: provides the service of lossless application migration.

Application scheduling management: provide application computing scheduling management.

It should be pointed out that the device on the computing scheduling management side according to the present disclosure at least corresponds to the above-mentioned application scheduling management, and of course, it can also include at least one of the above-mentioned computing management and application migration service.

FIG. 5B illustrates a flowchart of a method for computing scheduling management side according to an exemplary embodiment of the present disclosure. The method 520 includes step S521 (a first collection step) of collecting computing related information, wherein the computing includes shareable computing that can be provided by a computing provider side: step S523 (a second collection step) of collecting information about an application on a computing consumer side that needs to utilize the computing, and step S525 (a scheduling step) of performing computing scheduling for the application based on the computing related information and the information about the application, wherein the information about the application includes application attribute information, and the computing scheduling for the application includes corresponding computing scheduling for the application based on the application attribute.

It should be noted that the method according to the present disclosure may further include operation steps corresponding to the operations performed by the processing circuit of the above-mentioned device, such as the above-mentioned transmission step, optional prediction step 527, various scheduling operations, etc., which will not be described in detail here. It should be pointed out that the operations of the method according to the present disclosure can be performed by the computing resource scheduling manager as mentioned above, especially by the processing circuit or the corresponding unit, and will not be described in detail here.

According to another embodiment of the present disclosure, a device for a computing resource provider side in a wireless communication system is proposed. The computing resource provider side can provide temporary computing resource for the scheduling side to schedule, and then can communicate with the terminal to which the computing is scheduled, so that the terminal can use the computing to realize the application.

FIG. 11A illustrates a device on a computing resource provider side according to an embodiment of the present disclosure. The device 1100 may include a processing circuit 1102 configured to collect computing related information, wherein the computing includes shareable computing that can be provided by a computing provider side, provide the computing related information to a device on a computing scheduling management side, and receive relevant information about computing scheduling from the device on the computing scheduling management side, so that an application on a computing consumer side indicated in the relevant information about computing scheduling can utilize the computing to provide a service.

In some embodiments, the processing circuit is further configured to: collect information about the operation condition of the computing provider side device, including at least one of the network communication conditions and the service supply conditions of the computing provider side; and predict temporary computing resource based on the relevant information about the operation conditions of the computing provider side device to obtain the temporary computing resource related information.

In some embodiments, the information about the operation condition of the computing provider side may include at least one of historical operation data and real-time operation data of the computing provider side device, and the processing circuit is further configured to: predict a first temporary computing resource based on historical operation data on the computing provider side; and update the predicted first temporary computing resource based on the real-time operation data on the computing provider side, as the temporary computing resource available from the computing provider side device.

In some embodiments, the processing circuit is further configured to: send information that the temporary computing resource is available to the device on the computing scheduling management side, so that the device on the computing scheduling management side can schedule the temporary computing resource for the application; and/or send information that temporary computing resource is unavailable to the computing scheduling management side device, and recover the temporary computing resource for execution of its own application.

The device on the computing resource provider side can be realized in various ways, similar to the device on the computing resource scheduling side. In one example, the device for the computing provider side according to the present disclosure may include units for performing the operations performed by the processing circuit as described above, as shown in FIG. 11A, which illustrates a schematic block diagram of the device for the computing resource provider side. The device 1100 may include a processing circuit 1102, which may include an collection unit 1104, a transmission unit 1106, a reception unit 1108, and a prediction unit 1112, which may be configured to perform the operations performed by the processing circuit as described above, and may be implemented in an appropriate manner as described above.

FIG. 11B illustrates a flowchart of a method for a computing provider side according to an exemplary embodiment of the present disclosure. The method 1110 includes step S1111 (collection step) of collecting computing related information, wherein the computing includes shareable computing that can be provided by a computing provider side, step S1113 (transmission step) of providing the computing related information to a device on a computing scheduling management side, and step S1115 (receiving step) of receiving relevant information about computing scheduling from the device on the computing scheduling management side, so that an application on a computing consumer side indicated in the relevant information about computing scheduling can utilize the computing to provide a service

It should be pointed out that the method according to the present disclosure may further include operation steps corresponding to the operations performed by the processing circuit of the device on the computing provider side, such as information reception and transmission, temporary computing resource prediction, etc. as described above, which will not be described in detail here. It should be pointed out that the operations of the method according to the present disclosure can be performed by the device on the computing resource provider side, particularly by the processing circuit or corresponding units, and will not be described in detail here.

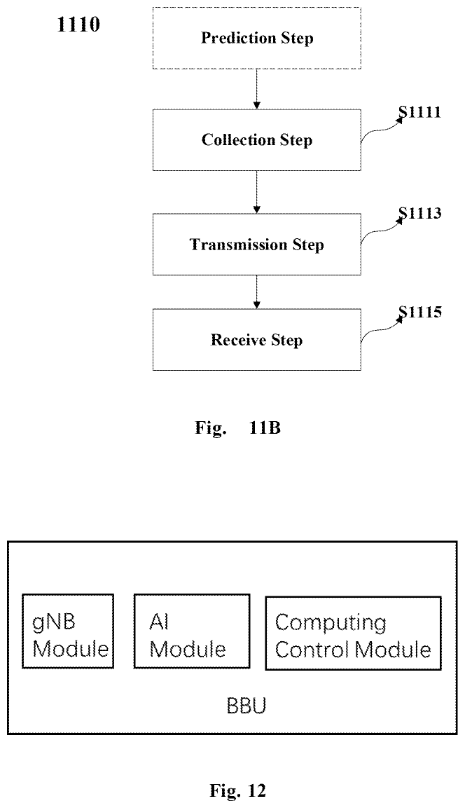

FIG. 12 illustrates an exemplary implementation of a BBU according to an embodiment of the present disclosure. The device may include:

gNB module: provides standard 3GPP 5G NR protocol and communication capacity.

AI module: provides AI algorithm prediction and determines BBU service status.

Computing control module: manage the temporary computing resources of BBU and interact with an external computing scheduler.

It should be pointed out that the device on the computing provider side according to the embodiment of the present disclosure can at least correspond to the computing control module here, and of course, it can also include the above-mentioned gNB module and AI module.

It should be noted that the above description is only exemplary. The embodiments of the present disclosure can also be implemented in any other appropriate way, and the advantageous effects obtained by the embodiments of the present disclosure can still be achieved. In addition, the embodiment of the present disclosure can also be applied to other similar application examples, and the beneficial effects obtained by the embodiment of the present disclosure can still be achieved. It should be understood that machine-executable instructions in a machine-readable storage medium or program product according to embodiments of the present disclosure may be configured to perform operations corresponding to the above-described apparatus and method embodiments. When referring to the above-mentioned device and method embodiments. The embodiments of machine-readable storage media or program products are clear to those skilled in the art, and therefore the description will not be repeated. Machine-readable storage media and program products for carrying or including the above machine-executable instructions also fall within the scope of this disclosure. Such storage media may include, but not limited to, floppy disks, optical disks, magneto-optical disks, memory cards, memory sticks, and the like.

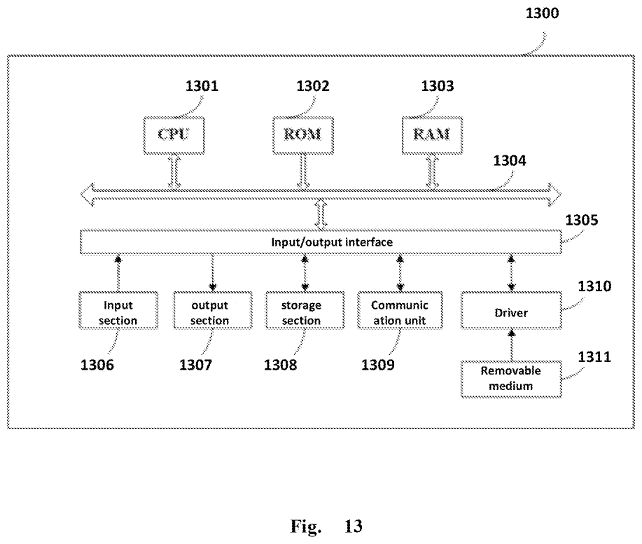

In addition, it should be understood that the above series of processes and devices can also be implemented by software and/or firmware. In the case of being implemented by software and/or firmware, the corresponding programs constituting the corresponding software are stored in the storage medium of a relevant device, and when the programs are executed, various functions can be realized. As an example, a program constituting the software can be installed from a storage medium or a network to a computer with a dedicated hardware structure, such as a general-purpose personal computer 1300 shown in FIG. 13, and the computer can implement various functions and the like when various programs are installed. FIG. 13 is a block diagram showing an example structure of a personal computer of an information processing apparatus that can be employed in an embodiment of the present disclosure. In one example, the personal computer may correspond to the device on the computing scheduling management side or the device on the computing provider side according to the present disclosure as mentioned above.

In FIG. 13, a central processing unit (CPU) 1301 executes various processes according to a program stored in a read-only memory (ROM) 1302 or a program loaded into a random access memory (RAM) 1303 from a storage section 1308. In RAM 1303, data required when the CPU 1301 executes various processes and the like are also stored as necessary.

CPU 1301, ROM 1302 and RAM 1303 are connected to each other via bus 1304. An input/output interface 1305 is also connected to the bus 1304.

The following components are connected to the input/output interface 1305: an input part 1306 including a keyboard, a mouse, etc.: an output section 1307 including a display, such as a cathode ray tube (CRT), a liquid crystal display (LCD), and a speaker: a storage section 1308 including a hard disk and the like; and a communication section 1309 including a network interface card such as a LAN card, a modem, and the like. The communication section 1309 performs communication processing via a network such as the Internet.

The driver 1310 is also connected to the input/output interface 1305 as needed. A removable medium 1311, such as a magnetic disk, an optical disk, a magneto-optical disk, a semiconductor memory, etc., is installed on the drive 1310 as needed, so that a computer program read from it is installed in the storage section 1308 as needed.

In the case where the above-mentioned series of processes are realized by software, a program constituting the software is installed from a network such as the Internet or a storage medium such as the removable medium

It should be understood by those skilled in the art that this storage medium is not limited to the removable medium 1311 shown in FIG. 13, in which the program is stored and distributed separately from the device to provide the program to users. Examples of the removable medium 1311 include a magnetic disk (including a floppy disk (registered trademark)), an optical disk (including a CD-ROM and a digital versatile disk (DVD)), a magneto-optical disk (including a mini disk (MD) (registered trademark)) and a semiconductor memory. Alternatively, the storage medium may be a ROM 1302, a hard disk contained in the storage section 1308, etc., in which programs are stored and distributed to users together with devices containing them.

For example, in the above embodiments, a plurality of functions included in one unit can be realized by separate devices. Alternatively, a plurality of functions realized by a plurality of units in the above embodiments may be realized by separate devices, respectively. In addition, one of the above functions can be realized by multiple units. Needless to say, such a configuration is included in the technical scope of this disclosure.

In this specification, the steps described in the flowchart include not only the processes that are performed in time series in the stated order, but also the processes that are performed in parallel or individually but not necessarily in time series. In addition, even in the steps of time series processing, it goes without saying that the order can be appropriately changed.

Although the present disclosure and its advantages have been described in detail, it should be understood that various changes, substitutions and alterations can be made hereto without departing from the spirit and scope of the present disclosure as defined by the appended claims. Furthermore, the terms “including”, “comprising”, or any other variation thereof, of the embodiments of the present disclosure are intended to encompass non-exclusive inclusion, such that a process, method, article, or device that includes a series of elements includes not only those elements, but also includes other elements not explicitly listed, or those inherent in the process, method, article, or equipment. Without more restrictions, the elements defined by the sentence “including a . . . ” do not exclude the existence of other identical elements in the process, method, article, or equipment including the elements.

Although some specific embodiments of the present disclosure have been described in detail, those skilled in the art should understand that the above-described embodiments are merely illustrative and do not limit the scope of the present disclosure. Those skilled in the art should understand that the above-described embodiments may be combined, modified, or replaced without departing from the scope and essence of the present disclosure. The scope of the present disclosure is defined by the appended claims.

What is claimed is:

1. A device on a computing scheduling management side in a wireless communication system, comprising a processing circuit configured to:
collect computing related information, wherein the computing includes shareable computing that can be provided by a computing provider side in the wireless communication system;
collect information about an application on a computing consumer side in the wireless communication system that needs to utilize the computing, and
perform computing scheduling for the application based on the computing related information and the information about the application,
wherein the information about the application includes application attribute information, and the computing scheduling for the application includes corresponding computing scheduling for the application based on the application attribute.

2. The device of claim 1, wherein,
the application includes at least one of a basic application and an extended application, and the computing scheduling for the application includes allocating at least one of a fixed computing and a dynamic computing for at least one of the basic application and the extended application, respectively.

3. The device of claim 1, wherein the shareable computing is temporary computing resource from the computing provider side other than basic computing, wherein the basic computing indicates the computing required by the computing provider side to meet a specific business requirement.

4. The device of claim 1, wherein the shareable computing is estimated based on information related to operating conditions of the computing provider side, and/or wherein the operating conditions of the computing provider side includes at least one of a network communication condition and a service supply condition of the computing provider side.

5. The device of claim 4, wherein the information related to the operation conditions of the computing provider side includes at least one of historical operation data and real-time operation data of the computing provider side, and
wherein the shareable computing is estimated by:
predicting a first temporary computing resource based on the historical operation data of the computing provider side; and
updating the predicted first temporary computing resource based on the real-time operation data of the computing provider side, as the shareable computing that can be provided by a device on the computing provider side.

6. The device of claim 1, wherein the processing circuit is further configured to:
preferentially deploy the fixed computing for basic applications, and/or preferentially deploy the dynamic computing for extended applications.

7. The device of claim 1, wherein the processing circuit is further configured to:
deploy extended applications to fixed computing, and
if required by the basic application, utilize the fixed computing corresponding to the extended application for the basic application, and/or
when dynamic computing is available, migrate the extended application from fixed computing to dynamic computing.

8. The device of claim 1, wherein the processing circuit is further configured to:
deploy the basic application to the dynamic computing, and
when the fixed computing is available, migrate the basic application to the fixed computing, and/or
when the dynamic computing allocated for the basic application is no longer available, but the basic application cannot be migrated to the fixed computing,
at least abandon the basic application, or
apply the dynamic computing applied to the extended application to the basic application, and/or
increase the priority of the basic application to be higher than that of the extended application, and
deploy the computing occupied by low-priority extended applications for high-priority basic applications.

9. A device for a computing scheduling management side in a wireless communication system, comprising:
at least one processor,
at least one storage device storing executable instructions thereon that, when executed by the at least one processor, cause the at least one processor to:
collect computing related information, wherein the computing includes shareable computing that can be provided by a computing provider side in the wireless communication system;
collect information about an application on a computing consumer side in the wireless communication system that needs to utilize the computing, and
perform computing scheduling for the application based on the computing related information and the information about the application,
wherein the information about the application includes application attribute information, and the computing scheduling for the application includes corresponding computing scheduling for the application based on the application attribute.

10. The device of claim 9, wherein,
the application includes at least one of a basic application and an extended application, and the computing scheduling for the application includes deploying at least one of a fixed computing and a dynamic computing for at least one of the basic application and the extended application, respectively.

11. The device of claim 9, wherein the shareable computing is temporary computing resource from the computing provider side other than basic computing, wherein the basic computing indicates the computing required by the computing provider side to meet a specific business requirement.

12. The device of claim 9, wherein the shareable computing is estimated based on information related to operating conditions of the computing provider side, and/or
wherein the operating conditions of the computing provider side includes at least one of a network communication condition and a service supply condition of the computing provider side.

13. The device of claim 12, wherein the information related to the operation conditions of the computing provider side includes at least one of historical operation data and real-time operation data of the computing provider side, and
wherein the shareable computing is estimated by:
predicting a first temporary computing resource based on the historical operation data of the computing provider side; and
updating the predicted first temporary computing resource based on the real-time operation data of the computing provider side, as the shareable computing that can be provided by a device on the computing provider side.

14. The device of claim 9, wherein the executable instructions, when executed by the at least one processor, further cause the at least one processor to:
preferentially deploy the fixed computing for basic applications, and/or
preferentially deploy the dynamic computing for extended applications.

15. The device of claim 9, wherein the executable instructions, when executed by the at least one processor, further cause the at least one processor to:
deploy extended applications to fixed computing, and
if required by the basic application, utilize the fixed computing corresponding to the extended application for the basic application, and/or
when dynamic computing is available, migrate the extended application from fixed computing to dynamic computing.

16. The device of claim 9, wherein the executable instructions t, when executed by the at least one processor, further cause the at least one processor to:
deploy the basic application to the dynamic computing, and
when the fixed computing is available, migrate the basic application to the fixed computing, and/or
when the dynamic computing allocated for the basic application is no longer available, but the basic application cannot be migrated to the fixed computing,
at least abandon the basic application, or
apply the dynamic computing applied to the extended application to the basic application, and/or
increase the priority of the basic application to be higher than that of the extended application, and
deploy the computing occupied by low-priority extended applications for high-priority basic applications.

17. A non-transitory computer readable storage medium storing instructions which, when executed by one or more processor, cause the one or more processor to
collect computing related information, wherein the computing includes shareable computing that can be provided by a computing provider side in the wireless communication system;
collect information about an application on a computing consumer side in the wireless communication system that needs to utilize the computing, and
perform computing scheduling for the application based on the computing related information and the information about the application,
wherein the information about the application includes application attribute information, and the computing scheduling for the application includes corresponding computing scheduling for the application based on the application attribute.

18. The non-transitory computer readable storage medium of claim 17, wherein, the instructions which, when executed by one or more processor, further cause the one or more processor to:
preferentially deploy the fixed computing for basic applications, and/or
preferentially deploy the dynamic computing for extended applications.

19. The non-transitory computer readable storage medium of claim 17, wherein the instructions which, when executed by one or more processor, further cause the one or more processor to:
deploy extended applications to fixed computing, and
if required by the basic application, utilize the fixed computing corresponding to the extended application for the basic application, and/or
when dynamic computing is available, migrate the extended application from fixed computing to dynamic computing.

20. The non-transitory computer readable storage medium of claim 17, wherein the instructions which, when executed by one or more processor, further cause the one or more processor to:
deploy the basic application to the dynamic computing, and
when the fixed computing is available, migrate the basic application to the fixed computing, and/or
when the dynamic computing allocated for the basic application is no longer available, but the basic application cannot be migrated to the fixed computing,
at least abandon the basic application, or
apply the dynamic computing applied to the extended application to the basic application, and/or
increase the priority of the basic application to be higher than that of the extended application, and
deploy the computing occupied by low-priority extended applications for high-priority basic applications.
